(19) United States
(12) Patent Application Publication
(10) Pub. No.: US 2012/0286542 A1
(43) Pub. Date: Nov. 15, 2012

(54) Vehicle upper part rear end structure

(75) Inventor: Hiroyuki KAKIUCHI, Hamamatsu (JP)

(73) Assignee: SUZUKI MOTOR CORPORATION, Hamamatsu (JP)

(21) Appl. No.: 13/460,301

(22) Filed: Apr. 30, 2012

(30) Foreign Application Priority Data
May 9, 2011 (JP) 2011-103951

(51) Int. Cl. B62D 25/08

(52) U.S. Cl. 296/203.04

(57) ABSTRACT

A roof exterior member of a hatchback vehicle is reinforced using a simple configuration. A vehicle upper part rear end structure includes a side-body exterior member, a side-body extension member connected near the rear end of the side-body exterior member, and a roof exterior member connected to the side-body exterior member and the side-body extension member. Furthermore, the vehicle upper part rear end structure includes a rear reinforcing member that is connected to the vehicle interior side of the roof exterior member and to the vehicle exterior side of the side-body exterior member and the side-body extension member, and that reinforces a region where these members overlap.

### CROSS-REFERENCE TO RELATED APPLICATIONS

This application is based upon and claims the benefit of priority from the prior Japanese Patent Application No. 2011-103951, filed on May 9, 2011, the entire contents of which are incorporated herein by reference.

### BACKGROUND

I. Field of the Invention

The present invention relates to a vehicle upper part rear end structure, which constitutes the vicinity of the corner of the rear end of the roof of a hatchback vehicle.

II. Background

A fundamental structure of a vehicle, such as a roof, may be formed by stacking a plurality of panel members to secure rigidity. It is known that in ordinary vehicles, loads are likely to be applied in a twisting direction (a twisting input) to the vicinity of the corner between the roof and the side body when the vehicle is traveling. In hatchback vehicles in particular, the rear part of the fundamental structure is largely open in order to install a hatchback door, and loads tend to be concentrated on the corner between the roof and the side body of the rear part. Accordingly, various panel members are stacked in the vicinity of the corner to increase rigidity.

For example, in the connecting structure of the rear part of a vehicle described in Japanese Patent Laid-open Publication No. 2005-161889, a reinforcing member called a rear pillar patch is provided at the aforementioned corner. This rear pillar patch is a member having a four-leg structure, and is connected to the C and D pillars, the side rail, and the rear rail. This rear pillar patch stretches diagonally in the vehicle fore-aft cross-section across the enclosed space formed by the roof panel (the roof exterior member) and the inner panel, and enhances the rigidity of the installed region.

The aforementioned twisting input is likely to affect the roof exterior member in particular. The roof exterior member is a large panel member of a vehicle, and is thus likely to be distorted when receiving a twisting input. However, making a large roof exterior member thicker is not efficient in terms of weight and cost increase. Moreover, the region of the rear pillar patch of Japanese Patent Laid-open Publication No. 2005-161889 contacting the roof exterior member is small, and therefore it seems that there is room for more efficiently protecting the roof exterior member.

In view of the foregoing problem, an object of the present invention is to provide a vehicle upper part rear end structure, which is capable of reinforcing a roof exterior member of a hatchback vehicle, using a cost-effective and simple configuration.

### BRIEF SUMMARY

Disclosed is an apparatus and method for a hatchback vehicle.

A roof exterior member of a hatchback vehicle is reinforced using a simple configuration. A vehicle upper part rear end structure includes a side-body exterior member, a side-body extension member connected near the rear end of the side-body exterior member, and a roof exterior member connected to the side-body exterior member and the side-body extension member. Furthermore, the vehicle upper part rear end structure includes a rear reinforcing member that is connected to the vehicle interior side of the roof exterior member and to the vehicle exterior side of the side-body exterior member and the side-body extension member, and that reinforces a region where these members overlap. The roof exterior member has an upper surface extending in a vehicle fore-aft direction, a rear surface bent downward from the rear end of the upper surface and facing the upper edge of a hatchback door, and a covering surface bent rearward from the rear surface and extending along the lower surface of the hatchback door, and the rear reinforcing member is bent along the upper surface, the rear surface, and the covering surface of the roof exterior member and welded to the respective surfaces.

In order to solve the foregoing problem, a typical configuration of a vehicle upper part rear end structure according to the present invention is as follows: a vehicle upper part rear end structure of a hatchback vehicle including a side-body exterior member, a side-body extension member connected to a vehicle interior side near a rear end of the side-body exterior member, a roof exterior member connected to a vehicle exterior side of the side-body exterior member and the side-body extension member, and a rear reinforcing member that is connected to a vehicle interior side of the roof exterior member and to a vehicle exterior side of the side-body exterior member and the side-body extension member, and that reinforces a region where the roof exterior member overlaps the side-body exterior member and the side-body extension member, the roof exterior member having an upper surface extending in a vehicle fore-aft direction, a rear surface bent downward from a rear end of the upper surface and facing an upper edge of a hatchback door, and a covering surface that is bent rearward from the rear surface and extends along a lower surface of the hatchback door, and the rear reinforcing member being bent along the upper surface, the rear surface, and the covering surface of the roof exterior member so as to be in contact with the respective surfaces and being welded thereto.

The rear reinforcing member can efficiently reinforce the vicinity of the corner of the vehicle rear part, to which loads due to a twisting input are particularly likely to be applied, of the roof exterior member. In particular, the rear reinforcing member is a small member that is provided in a minimal region where reinforcement is needed, and there is no possibility of excessively increasing either the vehicle weight or cost.

It is preferable that the rear reinforcing member has at least an upper welding region for welding to the upper surface and a rear welding region for welding to the rear surface, and the upper welding region and the rear welding region are disposed in positions different in a vehicle fore-aft direction and a vehicle width direction. According to this configuration, it is possible to efficiently disperse the aforementioned twisting input.

It is preferable that the vehicle upper part rear end structure further includes an inner member disposed to a vehicle interior side of the roof exterior member, the rear reinforcing member, the side-body exterior member, and the side-body extension member, the inner member has an operation hole for performing a welding operation at least on the rear welding region, and the rear welding region is tilted relative to the inner member towards a center of the operation hole. According to this configuration, it is possible to enhance the work efficiency when welding the rear reinforcing member, thereby contributing to labor and cost reduction.

According to the above-described configuration, it is possible to provide a vehicle upper part rear end structure, which is capable of reinforcing a roof exterior member of a hatchback vehicle, using a cost-effective and simple configuration.

According to some aspects, disclosed is a vehicle upper part rear end structure for a hatchback vehicle, the vehicle upper part rear end structure comprising: a side-body exterior member, a side-body extension member connected to a vehicle interior side near a rear end of the side-body exterior member, a roof exterior member connected to a vehicle exterior side of the side-body exterior member and the side-body extension member, and a rear reinforcing member that is connected to a vehicle interior side of the roof exterior member and to a vehicle exterior side of the side-body exterior member and the side-body extension member, and that reinforces a region where the roof exterior member overlaps the side-body exterior member and the side-body extension member, the roof exterior member having an upper surface extending in a vehicle fore-aft direction, a rear surface bent downward from a rear end of the upper surface and facing an upper edge of a hatchback door, and a covering surface bent rearward from the rear surface and extending along a lower surface of the hatchback door, the rear reinforcing member being bent along the upper surface, the rear surface, and the covering surface of the roof exterior member so as to be in contact with the respective surfaces and being welded thereto.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIGS. 1A and 1B are diagrams illustrating a vehicle to which a vehicle upper part rear end structure of an embodiment of the present invention is applied.

FIGS. 2A, 2B, and 2C are diagrams illustrating components underlying the vehicle upper part rear end structure of FIGS. 1A and 1B.

FIG. 3 is an enlarged diagram illustrating a rear reinforcing member of FIG. 2C.

FIGS. 4A and 4B show cross-sectional diagrams for FIG. 1B.

### DETAILED DESCRIPTION

Preferable embodiments of the present invention will now be described in detail below in reference to the accompanying drawings. Dimensions, materials, specific numerical values, etc., provided in the embodiments are merely illustrative to help understand the invention, and are not to limit the present invention unless indicated otherwise. In the specification and the drawings, elements that have essentially the same function or configuration are given the same numerical references to avoid repetitions in the description, and elements that are not directly related to the present invention are not shown in the drawings.

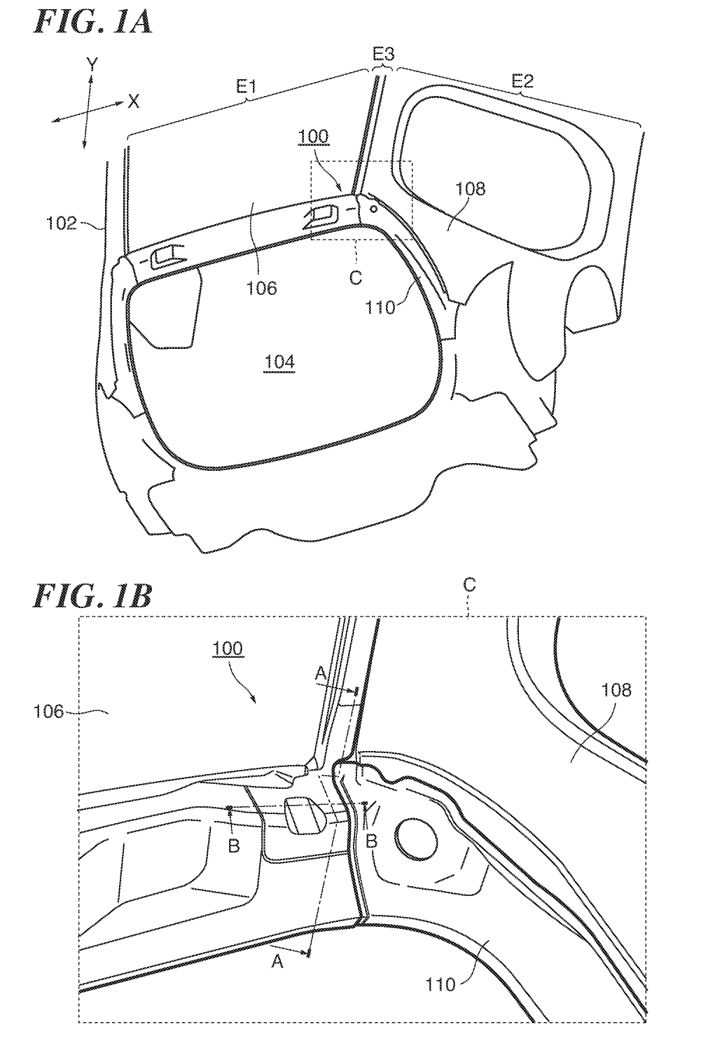

FIGS. 1A and 1B are diagrams illustrating a vehicle 102 to which a vehicle upper part rear end structure 100 of an embodiment of the present invention is applied. FIG. 1A is a perspective diagram illustrating the vehicle 102 as viewed from the right rear side and above. FIG. 1A shows only the fundamental structure composed of the panel members of the vehicle 102, and members such as doors and tires are omitted. In the illustrations including FIGS. 1A and 1B, the X axis indicates the vehicle width direction, the Y axis indicates the vehicle fore-aft direction, and the Z axis represents the vertical direction.

The vehicle upper part rear end structure 100 illustrated in FIGS. 1A and 1B is employed in the rear part of a hatchback vehicle such as the vehicle 102. Usually, a twisting input is likely to be applied to a corner E3 between a roof E1 and a side body E2 when the vehicle is traveling. In particular, in a hatchback vehicle such as the vehicle 102, a hatchback door region 104 is open in the rear part of the vehicle 102, and therefore, loads are likely to be concentrated on the rear end (area C) of the corner E3. When there is such a load concentration, there is a risk that a roof exterior member 106 is distorted. Therefore, in the present embodiment, the roof exterior member is efficiently reinforced with a configuration that will be described below.

FIG. 1B is an enlarged diagram of the area C in FIG. 1A. The vehicle upper part rear end structure 100 in the present embodiment includes the roof exterior member 106, a side-body exterior member 108, which is an exterior of the side body E2, and a side-body extension member 110 connected on the vehicle interior side, adjacent to the rear end of the side-body exterior member 108. Moreover, underlying these members are a plurality of panel members.

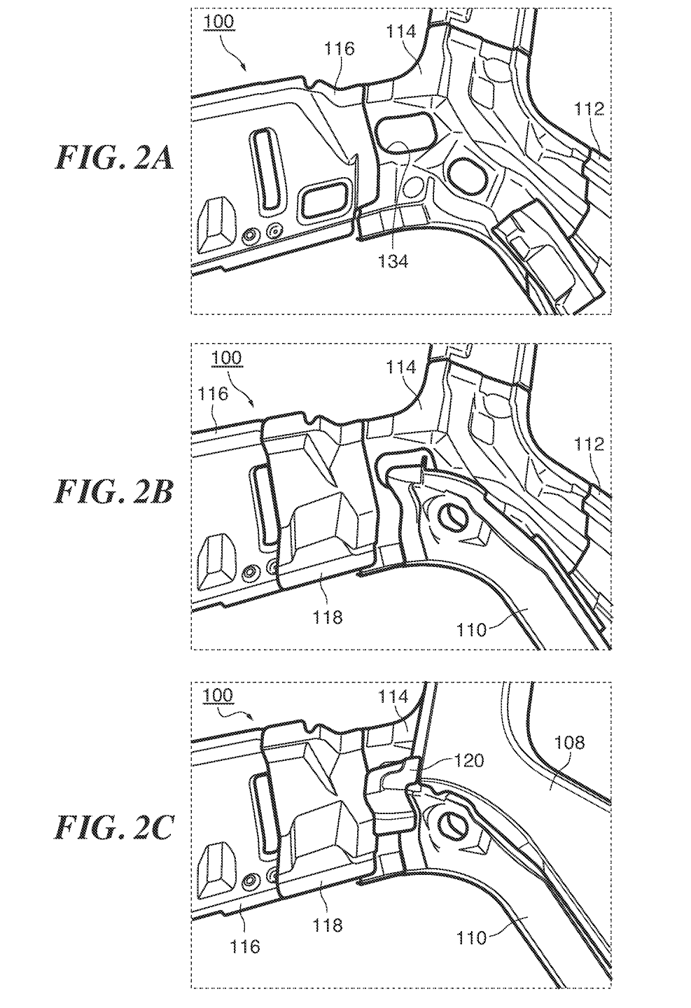

FIGS. 2A, 2B, and 2C are diagrams illustrating components underlying the vehicle upper part rear end structure 100 of FIGS. 1A and 1B. As shown in the diagrams of FIGS. 2A, 2B, and 2C, the respective panel members are placed one over another from the vehicle interior side (lower layer) to the vehicle exterior side (upper layer), according to the order of FIG. 2A to FIG. 2C.

As shown in FIG. 2A, the components underlying the vehicle upper part rear end structure 100, when roughly classified, include mainly an inner member 114 that constitutes the upper part of a rear pillar 112 of the side body E2 (see FIG. 1A), and a roof back member 116 that constitutes the rear part of the roof E1. The inner member 114 is the panel member among the panel members described below that is disposed on the innermost side of the vehicle. The roof back member 116 is disposed such that its end part is placed over the inner member 114, i.e., to the vehicle exterior side thereof.

FIG. 2B illustrates panel members placed over the members shown in FIG. 2A. As shown in FIG. 2B, the side-body extension member 110 is disposed on the rear side of the inner member 114. A hinge reinforcing member 118 is disposed such that the juncture between the inner member 114 and the roof back member 116 is covered. The hinge reinforcing member 118 is a member that reinforces the region where the hinge (not shown) of the hatchback door is attached.

FIG. 2C illustrates panel members placed over the members shown in FIG. 2B. As shown in FIG. 2C, the side-body exterior member 108 is disposed such that the front side of the inner member 114 and the front side of the side-body extension member 110 are covered. A rear reinforcing member 120 is disposed in the region where the side-body extension member 110 and the side-body exterior member 108 overlap. On the vehicle exterior side of these panel members, the roof exterior member 106 shown in FIGS. 1A and 1B is disposed. In this manner, the rear reinforcing member 120 reinforces the region where the roof exterior member 106, the side-body exterior member 108, and the side-body extension member 110 overlap.

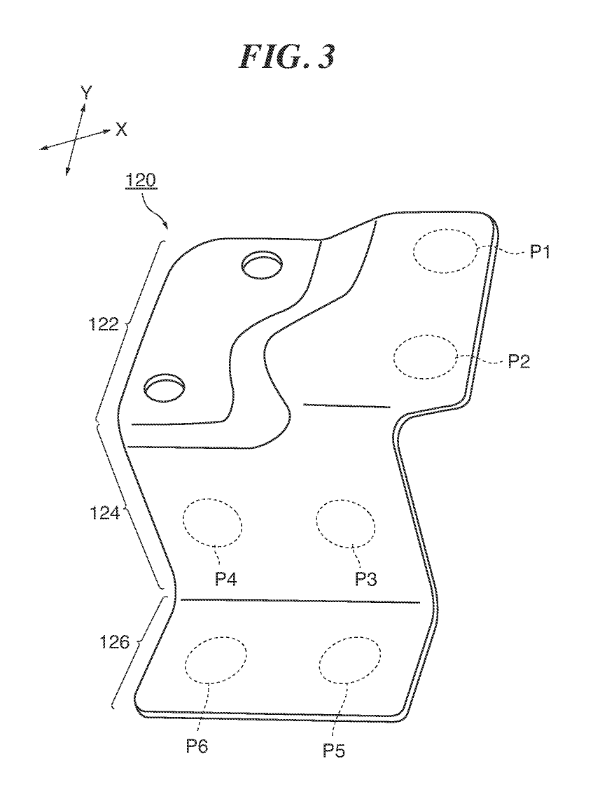

FIG. 3 is an enlarged diagram of the rear reinforcing member 120 of FIG. 2C. The rear reinforcing member 120 has a three-dimensional shape, and has a top surface 122 that extends in the vehicle fore-aft and right-left directions in the upper part, a vertical wall part 124 bent downward from the top surface 122, and a bottom part 126 bent rearward from the vertical wall part 124. These parts are shaped so as to extend along the roof exterior member 106 as described below.

In the present embodiment, six welding regions are provided in the rear reinforcing member 120 for spot welding to other panel members. First, a first welding region P1 and a second welding region P2 are arranged as upper welding regions in the top surface 122. Next, a third welding region P3 and a forth welding region P4 are arranged as rear welding regions in the vertical wall part 124. Then, a fifth welding region P5 and a sixth welding region P6 are arranged as bottom part welding regions in the bottom part 126.

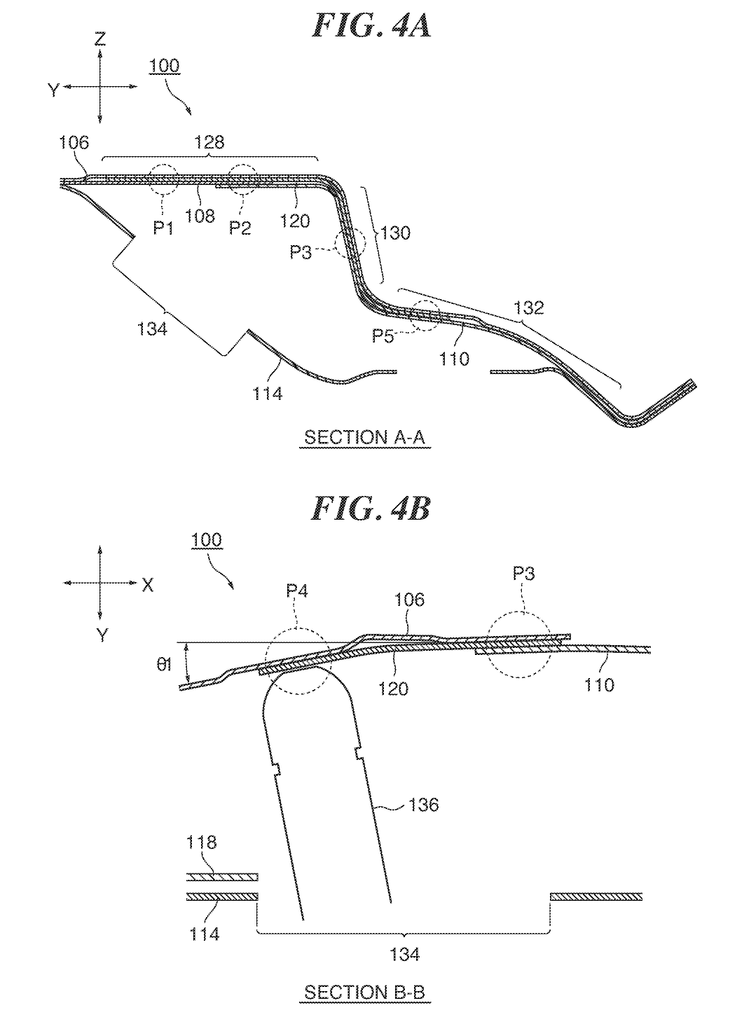

FIGS. 4A and 4B show cross-sectional diagrams for FIG. 1B. FIG. 4A is a cross-sectional diagram taken along the line A-A in FIG. 1B. As shown in FIG. 4A, the rear reinforcing member 120 is formed along the vehicle interior side of the roof exterior member 106 and the vehicle exterior side of the side-body exterior member 108 and the side-body extension member 110, and is connected to these.

A configuration of the rear reinforcing member 120 will now be described in detail. An upper surface 128 of the roof exterior member 106 of FIG. 4A extends in the vehicle fore-aft direction, and the top surface 122 of the rear reinforcing member 120 of FIG. 3 is formed along this upper surface 128. As shown in FIG. 4A, the rear reinforcing member 120 is spot-welded at the first welding region P1 to the roof exterior member 106 and the side-body exterior member 108. Also, the rear reinforcing member 120 is spot-welded at the second welded region P2 to the roof exterior member 106 and the side-body exterior member 108 as well as the side-body extension member 110.

Next, of the roof exterior member 106, a rear surface 130 is bent downward from the rear end of the upper surface 128. This rear surface 130 is a portion facing the upper edge of a hatchback door (not shown). Along this rear surface 130, the vertical wall surface of the rear reinforcing member 120 of FIG. 3 is formed. As shown in FIG. 4A, the roof exterior member 106 and the side-body extension member 110 are spot-welded at the third welding region P3 and the forth welding region P4 (see FIG. 3).

A covering surface 132 is formed such that the roof exterior member 106 of FIG. 4A is bent rearward from the rear surface 130 so as to extend along the lower surface of the hatchback door. The bottom part 126 of the rear reinforcing member 120 of FIG. 3 is formed along this covering surface. Then, as shown in FIG. 4A, spot-welding to the roof exterior member 106 and the side-body extension member 110 is achieved at the fifth welding region P5 and the sixth welding region P6 (see FIG. 3).

As described above, the rear reinforcing member 120 is bent along the upper surface 128, the rear surface 130, and the covering surface 132 of the roof exterior member 106 so as to be in contact with the respective surfaces and is welded thereto. In particular, as shown in FIG. 3, at least the upper welding regions (the first welding region P1 and the second welding region P2) and the rear welding regions (the third welding region P3 and the forth welding region P4) are disposed in positions different in the vehicle fore-aft direction and vehicle width direction. The phrase “positions different in the vehicle fore-aft direction” means that the Y coordinate of the first welding region P1/the second welding region P2 (for example, it may be the Y coordinate at the center of these regions; the same also applies below) and the Y coordinate of the third welding region P3/the forth welding region P4 are different. The phrase “positions different in the vehicle width direction” means that the X coordinate of the first welding region P1/the second welding region P2 and the X coordinate of the third welding region P3/the forth welding region P4 are different. This configuration enables the rear reinforcing member 120 to efficiently spread the twisting input generated when the vehicle is traveling.

Regarding the aforementioned welding regions, the welding operation on the third welding region P3 and the forth welding region P4 shown in FIG. 3 is carried out by inserting a welding apparatus 136 (see FIG. 4B) into a work hole 134 provided in the inner member 114 of FIG. 4A. FIG. 4B is a cross-sectional diagram taken along the line B-B in FIG. 1B. As shown in FIG. 4B, due to the surrounding structures, the range for forming the work hole 134 is restricted. As a result, it may be possible that, for example, vertically aiming the welding apparatus 136 at the forth welding region P4 is difficult.

Accordingly, in the present embodiment, the vertical wall part 124 of the rear reinforcing member 120 in which the forth welding region P4 is provided is formed so as to tilt by an angle of about θ1 relative to the inner member 114 towards the center side of the work hole 134. This configuration makes it possible to vertically aim the welding apparatus 136 also when welding the rear reinforcing member 120. Work efficiency is enhanced in this manner, and it is thus possible to contribute to labor and cost reduction.

As described above, the rear reinforcing member 120 of the present embodiment can efficiently reinforce the vicinity of the corner E3 (see FIG. 1A) in the vehicle rear part, to which loads due to a twisting input tend to be applied, of the roof exterior member 106. In particular, the rear reinforcing member 120 of FIG. 3 is a small member that has a simple configuration and that is provided in a minimal region where reinforcement is needed, and there is no possibility of excessively increasing either the vehicle weight or cost, thus being preferable.

In the foregoing, preferable embodiments of the present invention have been described in reference to the accompanying drawings, but naturally the present invention is not limited to such embodiments. It is clear that a person skilled in the art will suitably perform various changes and modifications within the scope of the claims, and naturally it is understood that they are also encompassed with in the technical scope of the present invention.

The present invention can be used as a vehicle upper part rear end structure, which constitutes the vicinity of the corner of the rear end of the roof of a hatchback vehicle.

What is claimed is:

1. A vehicle upper part rear end structure for a hatchback vehicle, the vehicle upper part rear end structure comprising:
a side-body exterior member;
a side-body extension member connected to a vehicle interior side near a rear end of the side-body exterior member;
a roof exterior member connected to a vehicle exterior side of the side-body exterior member and the side-body extension member; and
a rear reinforcing member that is connected to a vehicle interior side of the roof exterior member and to a vehicle exterior side of the side-body exterior member and the side-body extension member, and that reinforces a region where the roof exterior member overlaps the side-body exterior member and the side-body extension member;
wherein the roof exterior member having an upper surface extending in a vehicle fore-aft direction, a rear surface bent downward from a rear end of the upper surface and facing an upper edge of a hatchback door, and a covering surface bent rearward from the rear surface and extending along a lower surface of the hatchback door; and
wherein the rear reinforcing member being bent along the upper surface, the rear surface, and the covering surface of the roof exterior member so as to be in contact with the respective surfaces and being welded thereto.

2. The vehicle upper part rear end structure according to claim 1, wherein the rear reinforcing member has at least:
an upper welding region for welding to the upper surface; and
a rear welding region for welding to the rear surface;
wherein the upper welding region and the rear welding region are disposed in positions different in a vehicle fore-aft direction and a vehicle width direction.

3. The vehicle upper part rear end structure according to claim 1, further comprising:
an inner member disposed to a vehicle interior side of the roof exterior member, the rear reinforcing member, the side-body exterior member, and the side-body extension member;
wherein the inner member having an operation hole for performing a welding operation at least on the rear welding region, and
wherein the rear welding region being tilted relative to the inner member towards a center of the operation hole.
